(19) United States
(12) Patent Application Publication
(10) Pub. No.: US 2008/0248825 A1
(43) Pub. Date: Oct. 9, 2008

(54) Method of Transmitting in an Uplink Direction From Mobile Stations Having a Plurality of Antennas

(75) Inventors: Bin Chul Ihm, Gyeonggi-do (KR); Jin Young Chun, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC., Seoul (KR)

(21) Appl. No.: 11/573,685

(22) PCT Filed: Aug. 16, 2005
(86) PCT No.: PCT/KR2005/002669

§ 371 Date: Jan. 18, 2008

(30) Foreign Application Priority Data
Aug. 17, 2004 (KR) 10-2004-0064550

(51) Int. Cl. H04B 7/00; H04B 1/02; H04B 1/06

(52) U.S. Cl. 455/517; 455/101; 455/269

(57) ABSTRACT

A method of transmitting uplink signals in a wireless communication system is disclosed. In the system, there is at least one mobile station (MS) which possesses at least three antennas. In operation, at least one signal is generated using a matrix which represents a combination of transmission signals for each antenna. Moreover, the uplink signals are transmitted using the at least one generated signal. Here, each MS has at least one antenna.

### TECHNICAL FIELD

The present invention relates to a method of transmitting information from mobile stations, and more particularly, to a method of transmitting in an uplink direction from mobile subscriber stations having a plurality of antennas.

### BACKGROUND ART

In an Orthogonal Frequency Division Multiplexing Access (OFDMA) system of IEEE 802.16e, a matrix indicating a combination of transmission signals for each antenna is constructed when a mobile station (MS) has three antennas. The matrix is constructed in a manner in which effective uplink transmission can take place.

In a multiple antenna system where a bases station (BS) or a MS has more than one antenna, a diversity gain in the time domain and the frequency domain can change based on how the transmission signals from each antenna in uplink or downlink directions are combined. FIG. 1 is an example illustrating a matrix for attaining diversity gain when a MS has two transmission antennas and one receiving antenna.

In FIG. 1, a matrix has a column and a row. The column of the matrix (A or B) represents signals transmitted via first and second antennas (ANT0 and ANT1) in order of transmission, and the row of the matrix represents time. More specifically, when matrix-A is used, first and second signals (S₁ and S₂) are transmitted in the first time frame via ANT0 and ANT1 of the first channel, respectively. Subsequently, in the next subsequent frame, second and first signals (−S₂* and S₁*) are transmitted via ANT0 and ANT1 of the second channel, respectively. Here, by assigning receiving values of the first channel and the second channel as r₀ and r₁, respectively, the receiving end can estimate the values of the symbols according to the following Equation 1.

Ŝ₁=h₀*·r₀+h₁·r₁*

Ŝ₂=h₀*·r₀+h₁·r₁* [Equation 1]

Here, h₀ and h₁ indicates the channel status of ANT0 and ANT1, respectively. Furthermore, h₀ and h₁ can be estimated from pilot signal patterns transmitted from each antenna.

The description of above relates to a system where the MS has three antennas. In the OFDMA system of IEEE 802.16e, as illustrated in FIG. 2, matrices (A, B, C) have been considered based on a BS having three antennas. Here, the signal estimation method in the receiving end is similar to the signal estimation method of a two-antenna system. As illustrated in FIG. 2, the matrices (A, B, C) can all be used where the BS supports three-antennas during downlink transmission. However, as illustrated in FIG. 3, the system can have two mobile stations (SS1, SS2) together support three antennas for transmitting in the uplink direction. Here, the first MS (SS1) can transmit using two antennas (ANT0 and ANT1) while the second MS (SS2) can transmit using one antenna (ANT2). As a result of SS1 transmitting via two antennas, ANT0 and ANT1 can share signals with each other while ANT2 cannot.

For example, if the matrices (A, B, C) of FIG. 2 are applied to the three-antenna MS of FIG. 3, SS1 transmits S₁ and S₂ via ANT0 and ANT1, respectively, and SS2 transmits S₃ and S₄ independently via ANT2 to the BS. Here, even though ANT1 can only transmit S₁ and S₂ and cannot transmit S₃ and S₄ in matrix-A, but since S₃ and S₄ has to be transmitted, matrix-A cannot be used. Similarly, the same restriction applies to matrix-B.

The problem exists in a system where a first MS uses two antennas for uplink transmission while a second antenna uses one antenna for uplink transmission. Matrix-A and matrix-B of FIG. 2 cannot be used. Even with using matrix-C, the problem of not being able to attain diversity gain in the time domain cannot be resolved.

### DISCLOSURE OF INVENTION

Accordingly, the present invention is directed to a method of transmitting in an uplink direction from mobile subscriber stations having a plurality of antennas that substantially obviates one or more problems due to limitations and disadvantages of the related art.

An object of the present invention is to provide a method of transmitting uplink signals in a wireless communication system where at least one mobile station (MS) has at least three antennas.

Another object of the present invention is to provide a method of receiving uplink signals in a wireless communication system where at least one mobile station (MS) has at least three antennas.

Yet another object of the present invention is to provide a method of transmitting and receiving uplink signals in a wireless communication system where at least one mobile station (MS) has at least three antennas.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of transmitting uplink signals in a wireless communication system where at least one mobile station (MS) has at least three antennas includes generating at least one signal using a matrix which represents a combination of transmission signals to be transmitted for each antenna and transmitting uplink signals using the generated matrix. Here, each MS has at least one antenna.

In another aspect of the present invention, a method includes receiving uplink signals in a wireless communication system where at least one mobile station (MS) has at least three antennas. Furthermore, the method includes receiving uplink signals transmitted by using at least one generated signal, wherein the generated signal is generated by using a matrix which represents a combination of transmission signals transmitted by each antenna.

In another aspect of the present invention, a method includes transmitting and receiving uplink signals in a wireless communication system where at least one mobile station (MS) has at least three antennas. The method further includes generating at least one signal using a matrix which represents a combination of transmission signals to be transmitted for each antenna. Moreover, the method includes transmitting uplink signals using the at least one generated signal and receiving uplink signals transmitted by using at least one generated signal. The generated signal is generated by using a matrix which represents a combination of transmission signals transmitted by each antenna. Here each MS has at least one antenna.

In another aspect of the present invention, a wireless communication system for transmitting uplink signals is introduced. The system comprises a mobile station (MS) which includes a controller for generating at least one signal using a matrix which represents a combination of transmission signals to be transmitted for each antenna. The MS further includes a transmitter for transmitting uplink signals using the at least one generated signal. Moreover, the system has at least one MS having at least three antennas and each MS has at least one antenna.

Yet, in another embodiment of the present invention, a wireless communication system for receiving uplink signals is introduced. The system comprises a base station (BS) which includes a receiver for receiving uplink signals transmitted by using at least one generated signal. Here, the generated signal is generated by using a matrix which represents a combination of transmission signals transmitted by each antenna. Moreover, the system has at least one MS having at least three antennas and each MS has at least one antenna.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is an example of matrices of a two-antenna system;

FIG. 2 is an example of matrices of a three-antenna system;

FIG. 3 is an example a three-antenna system; and

FIG. 4 is an example illustrating a matrix of a three-antenna system which supports mobile stations transmitting via three antennas.

FIG. 5 is an example of a structure of a wireless communication system illustrating the operation of transmitting and receiving information between the BS and the MS.

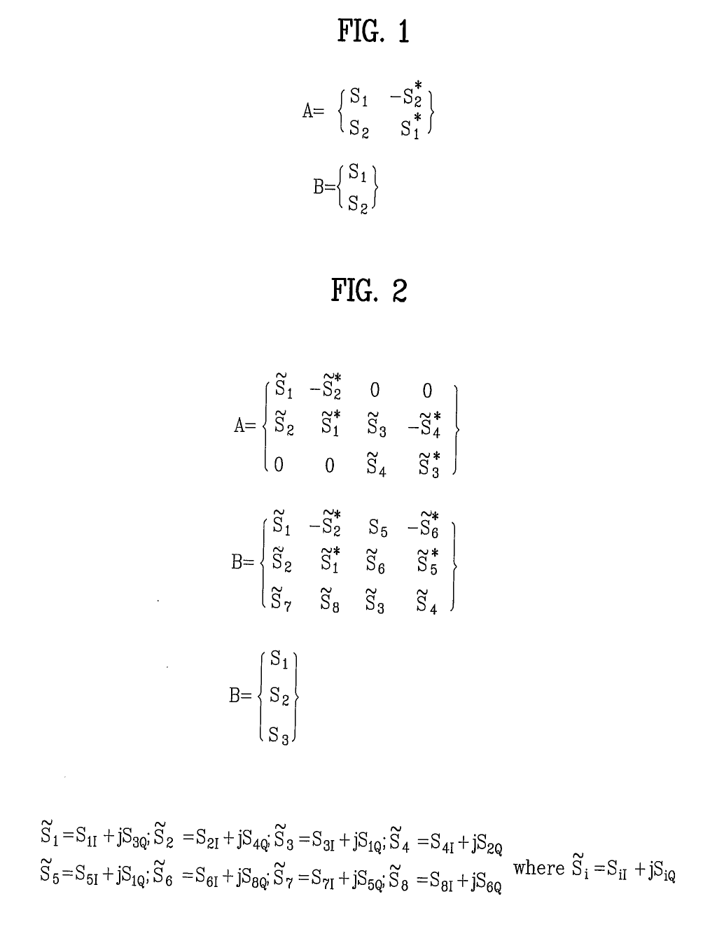

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

An embodiment of the present invention provides a method of transmitting signals in uplink direction from at least one mobile station having at least three antennas. To accomplish this, a matrix representing a combination of transmission signals for each antenna is generated and the uplink transmission takes place by using the generated matrix. The present embodiment provides a matrix capable of supporting mobile stations having at least three antennas, and for example, the matrix is capable of supporting a first mobile station having two antennas and a second mobile station has one antenna. However, the make up of number of antennas to a mobile station is not limited to the aforementioned structure. For example, a MS can have three antennas.

In the matrix of above, ANT0 and ANT2 share only each others' signals (S₁ and S₂) while ANT2 transmits signals S₁ and S₂ as well as independent signals S₃ and S ₄.

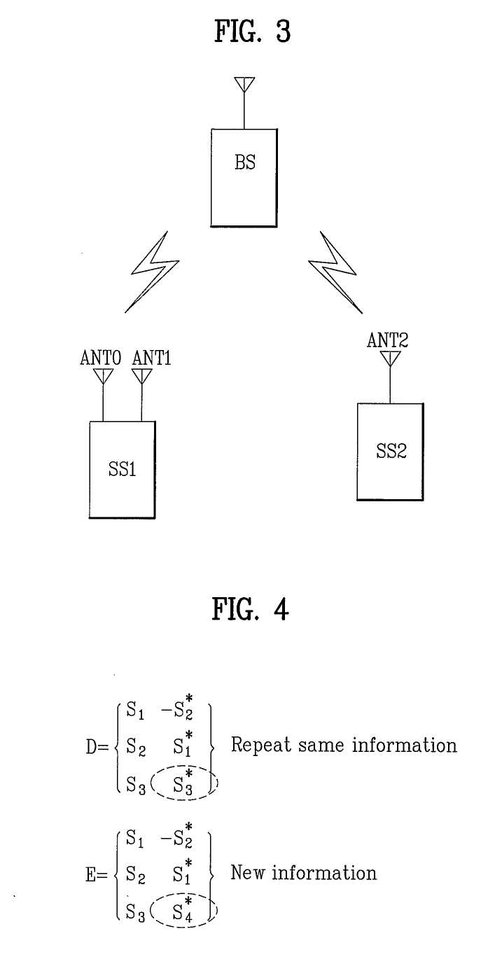

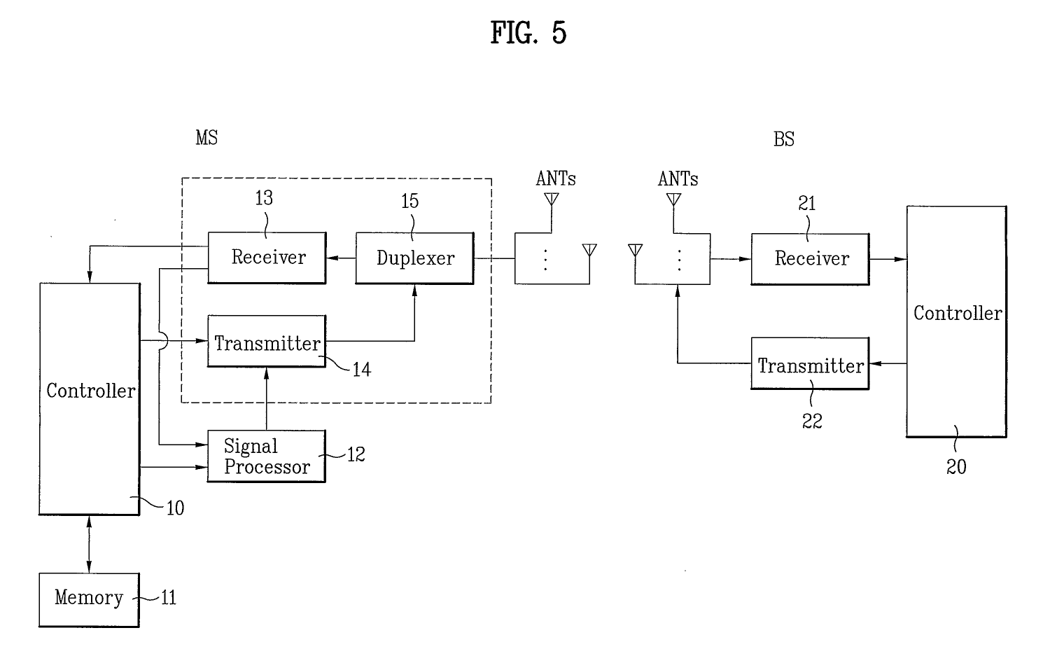

FIG. 3 is an example of a three-antenna system, and FIG. 4 is an example representing a matrix that supports mobile stations transmitting signals via three antennas. As illustrated in FIG. 4, because the signals transmitted via ANT0 and ANT1 can share information between each other, these two antennas can change the order of transmission to attain frequency diversity gain and time diversity gain. Moreover, since the signal transmitted via ANT2 is independent to those of ANT0 and ANT1, S₃ can be repeatedly transmitted as indicated in matrix-D. Furthermore, if S₃, which is transmitted via ANT2 at time (t), is successfully detected at the receiving end, by transmitting S₄ instead of S₃, greater amount of signals can be transmitted at subsequent time (t+1). Here, the rows of the matrix represent signals transmitted via antennas 0, 1, and 2 in order of antennas, and the columns of the matrix represent time (t, t+1 . . . ) in time sequence.

FIG. 5 is an example of a structure of a wireless communication system illustrating the operation of transmitting and receiving information between the BS and the MS. More specifically, a controller 10 generates at least one signal using a matrix which represents a combination of transmission signals to be transmitted for each antenna. Thereafter, a transmitter 14 transmits uplink signals using the at least one generated signal. In this system, the system has at least one MS having at least three antennas and each MS has at least one antenna. In addition, the system includes a BS which includes a receiver for receiving uplink signals transmitted by using at least one generated signal. Here, the generated signal is generated by using a matrix which represents a combination of transmission signals transmitted by each antenna.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method of transmitting uplink signals in a wireless communication system where at least one mobile station (MS) has at least three antennas, the method comprising:
generating at least one signal using a matrix which represents a combination of transmission signals to be transmitted for each antenna; and
transmitting uplink signals using the at least one generated signal,
wherein each MS has at least one antenna.

2. The method of claim 1, further comprising a first MS having two antennas and a second MS having one antenna.

3. The method of claim 1, further comprising a first MS having three antennas.

4. The method of claim 1, wherein the matrix represents the combination of transmission signals for attaining frequency diversity gain via uplink transmission from the two antennas of the first MS and for independently transmitting signals, which is different from the transmission signals of the first MS, from the antenna of the second MS.

5. The method of claim 4, wherein the signals transmitted from the two antennas of the first MS are shared between the two antennas.

6. The method of claim 4, wherein the antenna of the second MS transmits a first transmission signal at a first time period and a second transmission signal using the first transmission signal at a second time period.

7. The method of claim 6, wherein the second transmission signal is a conjugated signal of the first transmission signal.

8. The method of claim 4, wherein the antenna of the second MS transmits a different signal in a subsequent transmission time period from the signal of the previous transmission time period.

9. A method of receiving uplink signals in a wireless communication system where at least one mobile station (MS) has at least three antennas, the method comprising:
receiving uplink signals transmitted by using at least one generated signal, wherein the generated signal is generated by using a matrix which represents a combination of transmission signals to be transmitted by each antenna.

10. The method of claim 9, further comprising a first MS having two antennas and a second MS having one antenna.

11. The method of claim 9, further comprising a first MS having three antennas.

12. The method of claim 9, wherein the matrix represents the combination of transmission signals for attaining frequency diversity gain via uplink transmission from the two antennas of the first MS and for independently transmitting signals, which is different from the transmission signals from the first MS, from the antenna of the second MS.

13. The method of claim 12, wherein the signals transmitted from the two antennas of the first MS are shared between the two antennas.

14. The method of claim 12, wherein the antenna of the second MS transmits a first transmission signal at a first time period and a second transmission signal using the first transmission signal at a second time period.

15. The method of claim 14, wherein the second transmission signal is a conjugated signal of the first transmission signal.

16. The method of claim 12, wherein the antenna of the second MS transmits a different signal in a subsequent transmission time period from the signal of the previous transmission time period.

17. A method of transmitting and receiving uplink signals in a wireless communication system where at least one mobile station (MS) has at least three antennas, the method comprising:
generating at least one signal using a matrix which represents a combination of transmission signals to be transmitted for each antenna;
transmitting uplink signals using the at least one generated signal; and
receiving uplink signals transmitted by using at least one generated signal, wherein the generated signal is generated by using a matrix which represents a combination of transmission signals to be transmitted by each antenna,
wherein each MS has at least one antenna.

18. The method of claim 17, further comprising a first MS having two antennas and a second MS having one antenna.

19. The method of claim 17, further comprising a first MS having three antennas.

20. The method of claim 17, wherein the matrix represents the combination of transmission signals for attaining frequency diversity gain via uplink transmission from the two antennas of the first MS and for independently transmitting signals, which is different from the transmission signals from the first MS, from the antenna of the second MS.

21. The method of claim 20, wherein the signals transmitted from the two antennas of the first MS are shared between the two antennas.

22. The method of claim 20, wherein the antenna of the second MS transmits a first transmission signal at a first time period and a second transmission signal using the first transmission signal at a second time period.

23. The method of claim 22, wherein the second transmission signal is a conjugated signal of the first transmission signal.

24. The method of claim 20, wherein the antenna of the second MS transmits a different signal in a subsequent transmission time period from the signal of the previous transmission time period.

25. A wireless communication system for transmitting uplink signals, the system comprising a mobile station (MS) which includes:
a controller for generating at least one signal using a matrix which represents a combination of transmission signals to be transmitted for each antenna; and
a transmitter for transmitting uplink signals using the at least one generated signal,
wherein the system has at least one MS having at least three antennas and each MS has at least one antenna.

26. A wireless communication system for receiving uplink signals, the system comprising a base station (BS) which includes:
a receiver for receiving uplink signals transmitted by using at least one generated signal, wherein the generated signal is generated by using a matrix which represents a combination of transmission signals transmitted by each antenna, and wherein the system has at least one MS having at least three antennas and each MS has at least one antenna.
